(19) United States
(12) Patent Application Publication
(10) Pub. No.: US 2026/0300539 A1
(43) Pub. Date: Oct. 1, 2026

(54) DYNAMIC CONTEXT-BASED SECURITY MEASURES FOR PROTECTING USER DATA

(71) Applicant: International Business Machines Corporation, Armonk, NY (US)

(72) Inventors: Heather Nicole Polgrean, Lagrangeville, NY (US); Jeremy R. Fox, Georgetown, TX (US); Tiberiu Suto, Franklin, NY (US); Jessica Nahulan, Vaughan (CA)

(21) Appl. No.: 19/097,704

(22) Filed: Apr. 1, 2025

(51) Int. Cl. G06F 21/62; G06F 18/241

(52) U.S. Cl. CPC G06F 21/6245; G06F 18/241

(57) ABSTRACT

A method, according to one approach, comprises causing an artificial intelligence (AI) model to ingest a database associated with use of user data, and causing the AI model to, based on the ingestion, generate first classifications for the user data. The method further comprises causing the AI model to enforce security measures associated with the first classifications during a first collaboration event of a plurality of user devices, where the AI model determines and incorporates contextual information into the enforcement of the security measures. In response to receiving feedback associated with the enforcement of the security measures, the first classifications of the user data are updated to second classifications of the user data. A computer program product, according to another approach, comprises one or more computer-readable storage media, and program instructions stored on the one or more storage media to perform the foregoing method.

### BACKGROUND

The present invention relates to artificial intelligence (AI), and more specifically, this invention relates to use of AI to secure data.

Data storage allows information to be stored on one or more storage mediums. In networks, these different storage mediums may be located at the same location, or different locations. The storage of data is often subject to regulations. These regulations may be set and enforced by, e.g., a governing entity of a location of a storage medium on which the data is stored, a governing entity of a location that the data is transmitted to for an accessing user, a corporation that stores the data, etc.

Managing data security, moderation, and governance has become increasingly challenging due to complex regulatory and compliance policies that vary across companies and countries. These complexities are further compounded when handling confidential data, where specific segments are restricted to individuals based on their roles and access levels. This fragmented authorization can complicate data sharing, hinder day-to-day interactions with coworkers and customers, and pose significant risks if sensitive information is inadvertently disclosed, potentially resulting in costly security breaches for organizations.

### SUMMARY

A method, according to one approach, comprises causing an artificial intelligence (AI) model to ingest a database associated with use of user data, and causing the AI model to, based on the ingestion, generate first classifications for the user data. The method further comprises causing the AI model to enforce security measures associated with the first classifications during a first collaboration event of a plurality of user devices, where the AI model determines and incorporates contextual information into the enforcement of the security measures. In response to receiving feedback associated with the enforcement of the security measures, the first classifications of the user data are updated to second classifications of the user data.

A computer program product, according to another approach, comprises one or more computer-readable storage media, and program instructions stored on the one or more storage media to perform the foregoing method.

A computer system, according to another approach, comprises a processor set, one or more computer-readable storage media, and program instructions stored on the one or more storage media to cause the processor set to perform the foregoing method.

A method, according to another approach, comprises generating a training set of data, where the training set of data includes training user data, and using the training set of data to train an AI model. The training includes a first training task that includes training the AI model to generate first classifications for the training user data, and the training includes a second training task that includes training the AI model to determine first security measures associated with the first classifications during collaboration events of user devices. The method further comprises, in response to a determination that the AI model has, as a result of the training, reached at least a predetermined degree of accuracy, deploying the trained AI model to determine and enforce second security measures associated with second classifications during the collaboration events of the user devices in which confidential user data is shared between the user devices.

A computer program product, according to another approach, comprises one or more computer-readable storage media, and program instructions stored on the one or more storage media to perform the foregoing method.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach of the present invention.

FIG. 2 is a diagram of a tiered data storage system, in accordance with one approach of the present invention.

FIG. 3 is a flowchart of a method, in accordance with one approach of the present invention.

FIG. 4 is a diagram of an infrastructure associated with an AI model, in accordance with one approach of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for enabling dynamic context-based security measures for protecting user data.

In one general approach, a method comprises causing an artificial intelligence (AI) model to ingest a database associated with use of user data, and causing the AI model to, based on the ingestion, generate first classifications for the user data. The method further comprises causing the AI model to enforce security measures associated with the first classifications during a first collaboration event of a plurality of user devices, where the AI model determines and incorporates contextual information into the enforcement of the security measures. In response to receiving feedback associated with the enforcement of the security measures, the first classifications of the user data are updated to second classifications of the user data.

A technical effect of dynamically classifying the user data, including using feedback measures for potentially reclassifying the user data, includes ensuring that classifications and associated security measures are kept up to date with use case and environmental conditions of the user data.

The enforcement of the security measures may comprise generating a list of acceptable discussion topics and unacceptable discussion topics based on roles of users of the user devices and the first classifications, and causing entries of the list to be distributed and displayed on augmented reality (AR) interfaces of the user devices.

A technical effect of generating a list of acceptable discussion topics and unacceptable discussion topics based on roles of users of the user devices and the first classifications includes the enablement of streamlined collaboration events. Without such a list, users remain unaware of which topics are acceptable and which topics are unacceptable. Users being unaware of such topics would otherwise result in unauthorized use cases of at least some portions of user data which thereby compromises a security of the user data.

The enforcement of the security measures may comprise, in response to a determination that a discussion during the first collaboration event includes topics having at least a predetermined degree of similarity with the unacceptable discussion topics, performing a blocking action to prevent the unacceptable discussion topics from being shared.

A technical effect of selectively performing blocking actions includes the prevention of topics having at least a predetermined degree of similarity with the unacceptable discussion topics being covered during collaboration events. More specifically, the blocking actions serve as affirmative automated steps taken to ensure the security of the user data.

The enforcement of the security measures may comprise building an audit trail that details the enforcement of the security measures, where the audit trail includes logged instances of unauthorized disclosure of the user data. The enforcement of the security measures may additionally and/or alternatively comprise outputting a notification to an administrator device that details instances of the logged instances.

A technical effect of building and storing the audit trail includes refinement of an accuracy of the AI model. For example, the audit trail may be used to perform an audit to refine an accuracy of the AI model over time. For example, during downtime (less than a predetermined threshold workload) the AI model may use the audit trail to identify misclassifications of user data (as defined by a scenario in which missing context resulted in a classification of user data that incurred as least some latency in a data storage system associated with the user data). This way, the AI model may learn from these misclassifications and refine a classification accuracy by seeking and obtaining additional context in a next classification of the user data.

The method may further comprise causing the AI model to determine the security measures associated with the first classifications, where the determining the security measures associated with the first classifications includes: identifying that the first collaboration event is scheduled to occur, determining rules that users of the user devices are currently respectively subject to, and ordering the determined rules according to degrees of strictness. A relatively strictest rule of the ordered determined rules is enforced for the enforcement of the security measures. The determined rules may be determined based on relevant information selected from the group including primary locations of the users, current locations of the users, user roles of the users, and access privileges of the users.

Determination of security measures for the classifications of user data has a technical effect of ensuring that the user data is secured to an appropriate degree during use of the user data. More specifically, because different portions of user data may be classified differently (have different relative degrees of privacy, be subject to different restrictions and/or rules, etc.) the ongoing determination of the different security measures ensures that each portion of data is secured according to requirements of the classification. A technical effect of enforcing a relatively strictest rule of the ordered determined rules includes ensuring that users and/or user devices with relatively lower credentials that participate in collaboration events are not able to access user data that the credentials are not allowed to access. More specifically, the technical effect includes securing all user data by preventing users and/or user devices with relatively lower access credentials from being able to access some user data based on the attendance of users and/or user devices with relatively higher access credentials in the collaboration event.

The determining the security measures associated with the first classifications may include, in response to a determination that at least one of the user devices associated with a first of the users has logged off of the first collaboration event, re-determining the security measures associated with the first classifications.

A technical effect of dynamically determining security measures includes ensuring that changing conditions of collaboration events and/or changes to an environment in which the user data is being used do not result in a loss of security to the user data.

The AI model may use natural language processing (NLP) to ingest data governance measures of the database, where the security measures associated with the first classifications are determined based on the data governance measures.

A technical effect of using NLP to ingest the database includes streamlined processing of text-based information that the trained AI model is then able to use to secure the user data.

The database associated with use of user data details information may be selected from the group including security and compliance policies, confidential subject matter, geographical compliance regulations, and role and access privileges, where the contextual information may be selected from the group including an agenda for the first collaboration event, a meeting location for the first collaboration event, and environment settings of users of the user devices.

A technical effect of incorporating contextual information into the enforcement of the security measures includes alignment of the security measures that are enforced at any given time with conditions of an environment that the user data is being used in.

A computer program product, according to another approach, comprises one or more computer-readable storage media, and program instructions stored on the one or more storage media to perform the foregoing method. Similar technical effects are experienced.

A computer system, according to another approach, comprises a processor set, one or more computer-readable storage media, and program instructions stored on the one or more storage media to cause the processor set to perform the foregoing method. Similar technical effects are experienced.

A method, according to another approach, comprises generating a training set of data, where the training set of data includes training user data, and using the training set of data to train an AI model. The training includes a first training task that includes training the AI model to generate first classifications for the training user data, and the training includes a second training task that includes training the AI model to determine first security measures associated with the first classifications during collaboration events of user devices. The method further comprises, in response to a determination that the AI model has, as a result of the training, reached at least a predetermined degree of accuracy, deploying the trained AI model to determine and enforce second security measures associated with second classifications during the collaboration events of the user devices in which confidential user data is shared between the user devices.

A technical effect of generating the training set of data includes establishing data that can be used, via AI, to incorporate efficiencies into the process of securing data, and more particularly user data that is historically targeted by malicious actors. These efficiencies are established by the training set of data providing context about the historical typical operation of infrastructure associated with the user data. This way, non-typical operation of the infrastructure associated with the user data may be identified by the AI model to ensure that malicious actors do not exploit the user data. Furthermore, a technical effect of training the AI model for deployment includes the enablement of dynamic data storage practices into the technical field of data storage which has historically been plagued by inefficiencies associated with the static nature of traditional data classification systems. More specifically, these technical effects enable storage practices that are able to provide the nuanced adaptability needed to safeguard user data effectively by dynamically classifying user data and, based on these dynamic classifications, determining and enforcing accurate security measures.

A computer program product, according to another approach, comprises one or more computer-readable storage media, and program instructions stored on the one or more storage media to perform the foregoing method. Similar technical effects are experienced.

A method, according to a preferred approach, comprises causing an AI model to ingest a database associated with use of user data, causing the AI model to, based on the ingestion, generate first classifications for the user data, and causing the AI model to determine the security measures associated with the first classifications. The method further comprises causing the AI model to enforce the security measures associated with the first classifications during a first collaboration event of a plurality of user devices, where the AI model determines and incorporates contextual information into the enforcement of the security measures. In response to receiving feedback associated with the enforcement of the security measures, the first classifications of the user data are updated to second classifications of the user data.

A technical effect of dynamically classifying the user data, including using feedback measures for potentially reclassifying the user data, includes ensuring that classifications and associated security measures are kept up to date with use case and environmental conditions of the user data. Determination of security measures for the classifications of user data has a technical effect of ensuring that the user data is secured to an appropriate degree during use of the user data. More specifically, because different portions of user data may be classified differently (have different relative degrees of privacy, be subject to different restrictions and/or rules, etc.) the ongoing determination of the different security measures ensures that each portion of data is secured according to requirements of the classification.

A first technical use case example in which the techniques of the foregoing method may be deployed involves a data use environment of a multinational corporation. The multinational corporation is liable for ensuring that sensitive user data is protected across different global offices while adhering to regional data protection laws. These laws change over time, and thereby upon static policies and classifications becoming outdated, the user data becomes out of compliance and at risk. In order to mitigate the latencies and risks associated with these static policies, an AI model may be trained and deployed to perform data ingestion to determine classifications of the user data and appropriate security measures to enforce. Context evaluation is used by the AI model to generate the security measures that when enforced, these security measures restrict inappropriate topics and file-sharing from occurring in a meeting agenda and location. This dynamic and adaptive approach ensures regulatory compliance of the corporation.

A second use case example in which the techniques of the foregoing method may be deployed involves a company merger occurring. During the merger between two companies in different jurisdictions, a trained AI model may be used to dynamically assess and classify data from both companies, ensuring compliance with the strictest regulations. The AI model may generate tailored rules for integration processes, while real-time NLP processing monitors conversations to prevent data mishandling. AR integration for enforcing security measures, in some approaches, enhances security by visually flagging sensitive data with color-coded indicators and providing compliance prompts a field of view of users (wearing the AR component) during meetings (both internally and with clients). These visuals ensure secure and error-free data integration, enabling a seamless merger process while minimizing compliance risks.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dynamic security measure code of block 150 for enabling dynamic context-based security measures for protecting user data. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

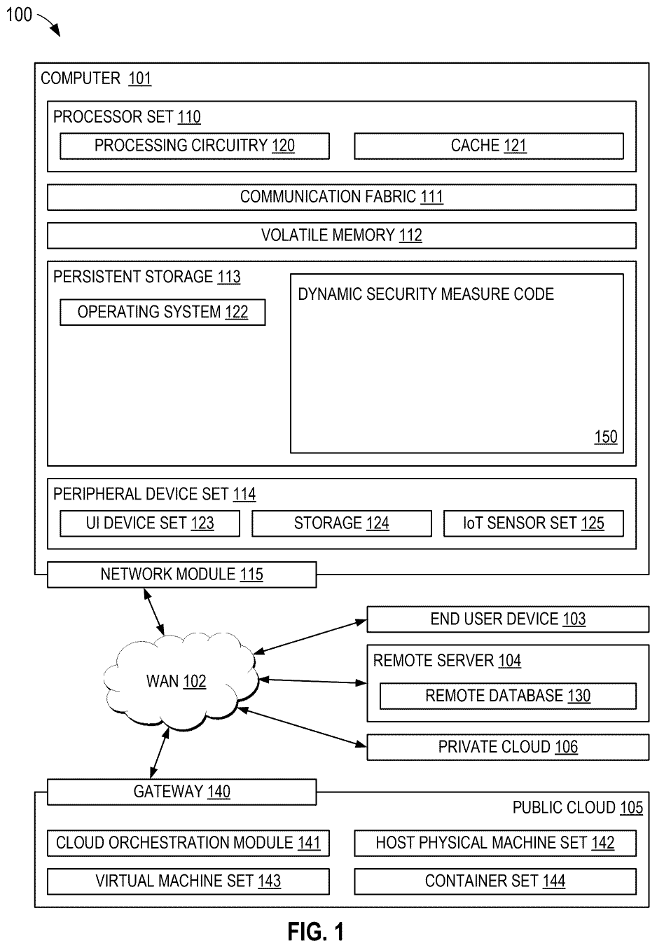

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

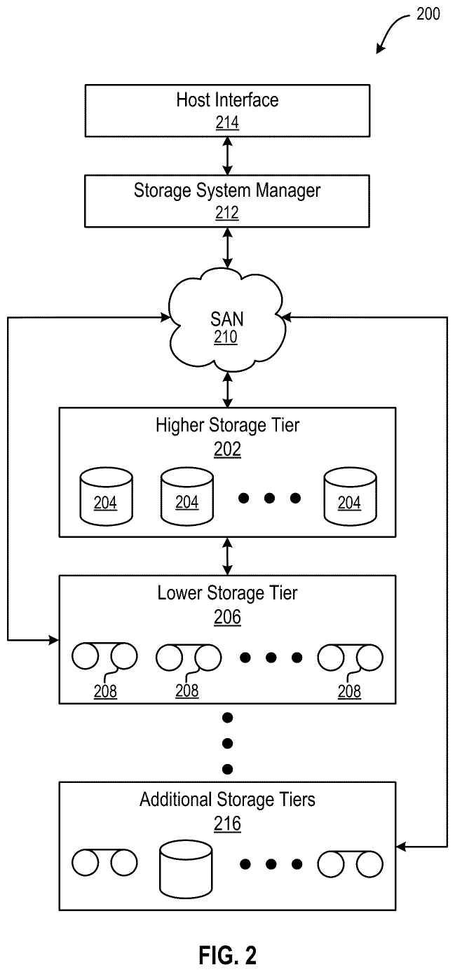

Now referring to FIG. 2, a storage system 200 is shown according to one approach. Note that some of the elements shown in FIG. 2 may be implemented as hardware and/or software, according to various approaches. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more approaches, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the approaches presented herein.

According to some approaches, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, data storage allows information to be stored on one or more storage mediums. In networks, these different storage mediums may be located at the same location, or different locations. The storage of data is often subject to regulations. These regulations may be set and enforced by, e.g., a governing entity of a location of a storage medium on which the data is stored, a governing entity of a location that the data is transmitted to for an accessing user, a corporation that stores the data, etc.

Managing data security, moderation, and governance has become increasingly challenging due to complex regulatory and compliance policies that vary across companies and countries. These complexities are further compounded when handling confidential data, where specific segments are restricted to individuals based on their roles and access levels. This fragmented authorization can complicate data sharing, hinder day-to-day interactions with coworkers and customers, and pose significant risks if sensitive information is inadvertently disclosed, potentially resulting in costly security breaches for organizations.

A key issue in conventional data storage practices lies in the static nature of traditional data classification systems. These systems fail to account for issues including, but not limited to, the dynamic factors influencing data sensitivity, such as changes in context, the presence of different participants, user location, and applicable geographical policies. As a result, these data storage practices are unable to provide the nuanced adaptability needed to safeguard information effectively. These deficiencies create additional workloads and latencies within conventional data storage systems based on the recovery procedure operations that are performed in order to recover from data security breach events.

To address these longstanding challenges within the technical field of data storage, there is a critical need for an innovative solution capable of dynamically adjusting data sensitivity classifications. In sharp contrast to the deficiencies described above, the techniques of approaches described herein enable a data storage system to respond in real time to the evolving context and content of conversations across various platforms and/or in-person interactions, ensuring robust data protection while enabling seamless and secure collaboration. In order to enable the data storage system to respond in such a way, the techniques of approaches described herein dynamically classify data sensitivity levels using advanced analytics, including contextual, geographical, environmental, and predictive data analysis. Furthermore, these approaches integrate machine learning, federated learning, and augmented reality to enhance data security, compliance, and user interaction with data.

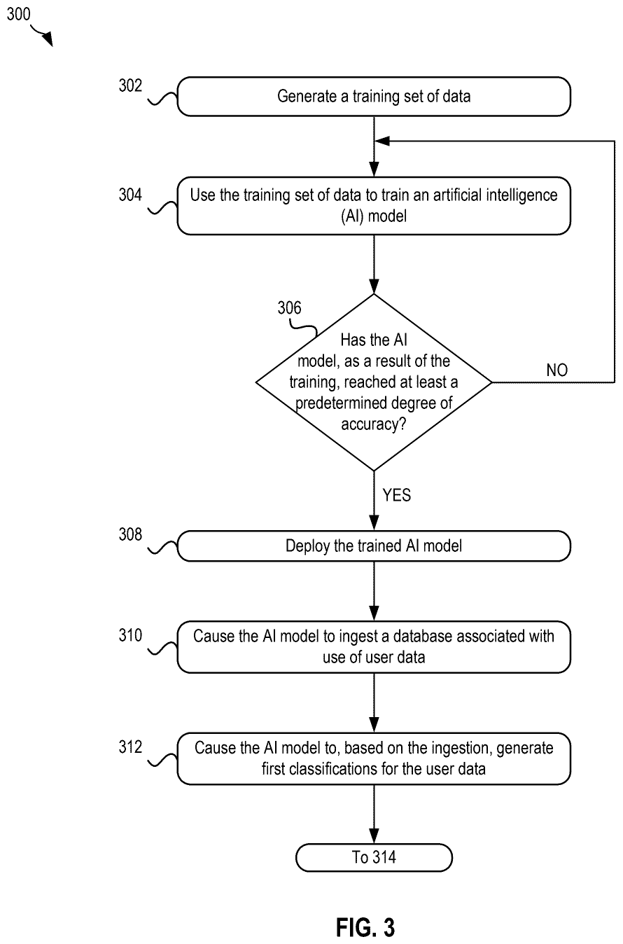

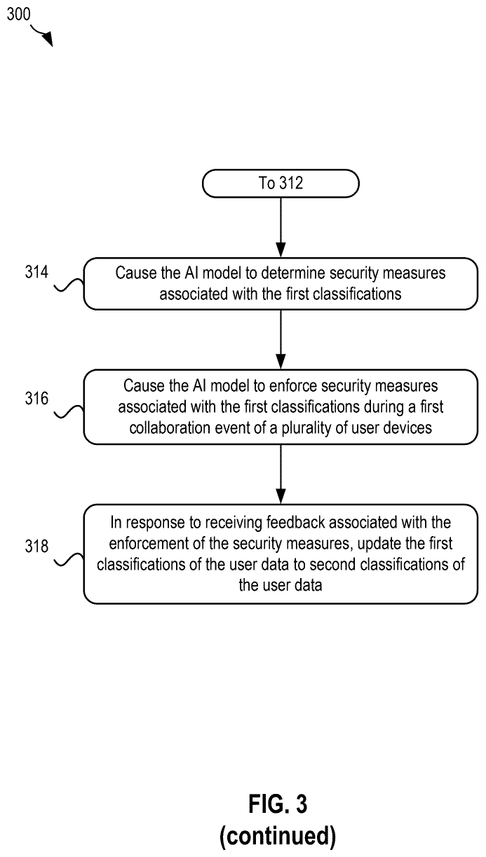

Now referring to FIG. 3, a flowchart of a method 300 is shown according to one approach. The method 300 may be performed in accordance with aspects of the present invention in any of the environments depicted in FIGS. 1-4, among others, in various approaches. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various approaches, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

In some preferred approaches, method 300 utilizes AI to perform operations of method 300. This AI is specifically deployed as an AI model of a type that would become apparent to one of ordinary skill in the art after reading the descriptions herein.

Operation 302 includes generating a training set of data. In some approaches, the training set of data is stored in a database. Generating the training set of data, in some approaches, includes transforming real user data of a data storage environment that an AI model, once trained, is deployed to secure. Data transformation techniques of a type that would become apparent to one of ordinary skill in the art may be used, in some approaches. In one or more approaches, the database, in some preferred approaches, is preferably maintained by dynamically updating the database during use of the user data and/or infrastructure associated with the user data in order to generate the training set of data. The database thereby includes information that details use of the user data, e.g., by one or more user devices. In some other approaches, the training set of data may be an independent training set of data (not associated with user data of the database).

A technical effect of generating the training set of data includes establishing data that can be used, via AI, to incorporate efficiencies into the process of securing data, and more particularly user data that is historically targeted by malicious actors. These efficiencies are established by the training set of data providing context about the historical typical operation of infrastructure associated with the user data. This way, non-typical operation of the infrastructure associated with the user data may be identified by the AI model to ensure that malicious actors do not exploit the user data.

Operation 304 includes using the training set of data to train the AI model. Training of the AI model, in some approaches, may be performed by applying the training data set to learn how to classify and then secure user data. In some of these approaches, this may be performed by causing the AI model to perform predetermined training tasks. For example, in some approaches, the training includes a first training task that includes training the AI model to generate first classifications for the training user data (classifications of a relative sensitivity of at least a portion of the training user data). Examples for different potential classifications for user data, e.g., training user data, are described below, according to various approaches.

In some preferred approaches, the classifications of user data may be based on degrees of privacy that the data is subject to. It should be noted that different portions of the user data are preferably potentially subject to one or more different classifications. For example, in some approaches, a first classification of the user data (and more specifically the training user data during training of the AI model) may include a relatively strict classification of user data. Portions of user data that are determined to be relatively high value data may be classified in the relatively strict classification of user data. User data may be classified as relatively high value data in response to a determination, by the AI model, that the user data is secure, confidential, sensitive, and/or high value data. In some approaches, this user data may be data that is typically (determined to be historically) subject to encryption during storage and decryption only during use of the data. This type of data, in some approaches, may include protected customer data, e.g., credit card numbers, banking statements, social security information, password information, user data subject to redaction, etc.

Another potential classification for user data includes user data that is protected to at least some degree, but less protected than the relatively high value data described above, yet not a relatively lowest degree of protection. Such user data may include user data that is not typically encrypted during storage and/or transmission, and that is not entirely available for public disclosure. This type of data, in some approaches, may include address information, user data that is scheduled to be disclosed to the public within a predetermined number of days, data that is partially redacted (so as to prevent the redacted information from ever becoming publicly available), etc.

Yet another potential classification for user data includes user data that is not protected. In some approaches, this user data may be defined as user data that is acceptable to entirely disclose to the public. This type of data, in some approaches, may include public forum comments, public phone numbers, pictures taken in public, etc.

In some approaches, the AI model's accuracy in performing one or more of the training tasks described herein may be achieved and refined over time using reward-based feedback. For example, initial training may include reward feedback that may, in some approaches, be implemented using a subject matter expert (SME) that generally understands whether the AI model correctly classifies portions of user data. However, to prevent costs associated with relying on manual actions of a SME, in another approach, reward feedback may be implemented using techniques for training a BERT model, as would become apparent to one skilled in the art after reading the present disclosure. Weight values may, in some approaches, be used by the AI model to collect and analyze information and/or feedback potentially received from user devices and/or feedback loops.

The training of the AI model may additionally and/or alternatively include a second training task, in some approaches. The second training task may include training the AI model to determine first security measures associated with the first classifications during collaboration events of user devices. For context, security measures may be defined as protocols and/or rules that the associated classification of data is subject to, e.g., first security measures may be associated with the first classification of the user data, second security measures may be associated with a second classification of the user data, third security measures may be associated with a third classification of the user data, etc.

The security measures that are associated with the classification of data may depend on the approach. However, in some preferred approaches, relatively stricter security measures are associated with and thereby preferably enforced against relatively higher value data, while in contrast, relatively less strict security measures are associated with and thereby preferably enforced against relatively lower value data. For context, the security measures may be designed to be performed by one or more actors. For example, in a first approach, the security measures may be rules that are visually presented to a user to follow, e.g., listing appropriate topics to discuss during collaboration events of user devices and other topics that are not to be discussed during the collaboration events of user devices. In another approach, the security measures may additionally and/or alternatively be command instructions the AI model enforces against one or more other user devices. For example, a first of the command instructions that the AI model enforces may result in one or more portions of an audio stream, video stream and/or text output of a user device from being filtered out, e.g., in response to the portion being determined to violate a rule. Various security measures will be described in greater detail elsewhere herein, e.g., see operations 314 and 316.

During training of the AI model, the model is, in some approaches, trained to consider and/or determine contextual information associated with use of the user data. This contextual information may then, in one or more of such approaches, be used to learn why and which security measures should be considered for enforcement. For context, in some approaches, the contextual information may be defined as any information that has a potential for defining use cases in which the user data will be used. Furthermore, the contextual information provides insight as to how the user data is historically used. For example, this context may detail whether a security measure should be enforced or not, e.g., is a first portion of user data being used in a collaboration session that includes a user that does not have credentials to know about the first portion of the user data, etc. A first example of such contextual information may include a meeting location for a first collaboration event in which at least some of the user data may be accessed and/or discussed. This information may provide context as to what security measures can be enforced against the user devices and/or users. For example, assuming that the first collaboration event is scheduled to occur in an office, the contextual information may define available internet bandwidths, cameras present in the office, microphones present in the office, users and/or user devices that may be within a listening range of the first collaboration event, and/or any other information that may be used to define tools and/or geographical boundaries of the first collaboration event. In some other approaches, the contextual information may be defined as any information that has a potential for defining an environment of the user devices that access the user data and/or users using the user devices. Examples of such contextual information may, in some approaches, include environment settings of users of the user devices that join the first collaboration event, e.g., whether the participants of the first collaboration event are located in a public or a private setting. In some other approaches, the contextual information may additionally and/or alternatively include agendas for previous collaboration events. These agendas, in some approaches, provide a historical context as to how the user data has been used over time which the AI model may use to further understand how the user data is typically used.

In some approaches, the AI model may be trained to develop a dynamic context evaluator component tailored to one or more specific audiences (user type based on credentials), environment, and/or platform where data sharing occurs.

Ongoing determinations may be made as to whether the AI model has achieved a redeemed threshold of accuracy of performing the one or more of the operations described herein during training, e.g., see decision 306. In response to a determination that such a threshold of accuracy has not yet been met, e.g., as illustrated by the “NO” logical path of decision 306, training of the model continues, in some approaches. In contrast, in some approaches, a decision that the AI model is trained and ready to deploy for performing techniques and/or operations of method 300 may be made, e.g., as illustrated by the “YES” logical path of decision 306. In response to a determination that the AI model has, as a result of the training, reached at least a predetermined degree of accuracy, the trained AI model is deployed, e.g., see operation 308. For context, and as will be described in greater detail elsewhere below, deployment of the AI model, in some preferred approaches, includes using the trained AI model to determine and enforce security measures associated with classifications of user data during collaboration events of user devices in which confidential user data is shared between the user devices and/or discussed.

A technical effect of training the AI model for deployment includes the enablement of dynamic data storage practices into the technical field of data storage which has historically been plagued by inefficiencies associated with the static nature of traditional data classification systems. More specifically, these technical effects enable storage practices that are able to provide the nuanced adaptability needed to safeguard user data effectively by dynamically classifying user data and, based on these dynamic classifications, determining and enforcing accurate security measures. It should be noted that the AI model may, in some approaches, be a neuromyotonic AI model that may improve performance of computer devices in an infrastructure associated with user data, because the neuromyotonic AI model may not need an SME and/or iteratively applied training with reward feedback in order to accurately perform operations described herein. This is an additional technical effect of use of the AI model.

As a part of deploying the AI model, in some approaches, the AI model is caused to ingest a database associated with use of user data, e.g., see operation 310. In some approaches, causing the AI model to ingest the database associated with use of user data includes instructing the AI model to analyze and/or learn characteristics associated with the historical use of infrastructure associated with user data and/or the historical use of the user data. These characteristics may be of a type that would become apparent to one of ordinary skill in the art after reading the descriptions herein and may or may not be user and/or user device specific characteristics, e.g., typical times that a user device and/or user of the user device access a portion of the user data, typical size of a download of user data that a user device and/or user of the user device perform, historical access credentials of a user device and/or user of the user device, etc.

The AI model, as a result of the ingestion, becomes familiar with a historical use of infrastructure associated with the user data. In one approach, this infrastructure includes a data storage system, e.g., data drives, storage servers, etc., of a type that would become apparent to one of ordinary skill in the art after reading the descriptions herein. According to another approach, the data storage system may be a tiered data storage system (see FIG. 2). The historical use of user data stored in the infrastructure described above may be recorded in a database associated with use of the user data. This use of the user data may, in some approaches, be defined by information including accesses of the user data, user data writes performed, user data reads performed, etc. In some other approaches, this use of the user data may additionally and/or alternatively be defined by temporal information, e.g., timestamps of the use of the user data, a duration of time that a given portion of the user data remained in a relatively higher storage tier versus a duration of time that the given portion of the user data remained in a relatively lower storage tier, a duration of time that user data was accessed by a user device, a time of day that user data is downloaded, etc.

The database ingested by the trained AI model may additionally and/or alternatively include information that details previous and/or current collaborative user sessions in which users that are participants of local and/or remote meetings use and/or discuss the user data. According to some approaches, this information that details previous and/or current collaborative user sessions may specify locations of these collaborative meetings. For context, location information for use of the user data may be pertinent for one or more reasons. For example, as will be described in greater detail elsewhere herein, user data may be subject to different regulations at different physical and/or virtual locations. Accordingly, in some approaches, the location at which different portions of the user data have been and/or are currently being used and/or are scheduled to be used may be detailed by the information of the database and thereby preferably learned by the AI model.

As indicated above, user data may be subject to different regulations at one time or another. Note that, in some approaches, these regulations may be independent of the location at which the user data is used and/or discussed. Accordingly, in some approaches, the database associated with the use of user data may detail information including security policies, regulations and/or compliance policies that the AI model learns. These regulations and policies may, in some of such approaches, include policies set by a corporation that owns and/or stores the user data. For example, the regulations and policies may include guidelines and regulations that employees must comply with including geographical regulations and enterprise policies. In some other approaches, the security and compliance policies may additionally and/or alternatively include policies set by a government and/or international treaty. In some approaches, these location based regulations may include geographical compliance regulations of a type that would become apparent to one of ordinary skill in the art after reading the descriptions herein, e.g., the California Consumer Privacy Act (CCPA), the Fair Credit Reporting Act (FCRA), the Family Educational Rights and Privacy Act (FERPA) for student data, the Gramm-Leach-Bliley Act (GLBA) for financial information, the European Union's General Data Protection Regulation (GDPR), etc.

In some approaches, the database associated with the use of user data may additionally and/or alternatively detail information including confidential subject matter. For context, the confidential subject matter may in some approaches, be portions of the user data itself. In contrast, the confidential subject matter may additionally and/or alternatively be tools used to secure the data, e.g., encryption key information that is used to encrypt and/or decrypt the user data.

The database associated with the use of user data may additionally and/or alternatively detail information including role and access privileges of user devices and/or users that may have access to the user data. In some approaches, this information includes user and context information that details identifying information about the users that have participated in past conversations and/or collaboration events in which the user data was shared, as well as context information associated therewith, e.g., a location of such events, a time of such events, user roles of participants of such events, etc. Depending on the approach, these roles and/or access privileges may be specific to, e.g., a company, a government, an education level, a job position, a service platform membership level, etc. In some approaches, these privileges are received from and/or obtained from applications, tools, and/or services associated with data management, security, and business processes, e.g., such as ENTERPRISE by INTERNATIONAL BUSINESS MACHINES CORPORATION (IBM).

In yet some further approaches, the database associated with the use of user data may additionally and/or alternatively detail information associated with data streams. For example, depending on the approach, various types of shared data may be obtained and stored in the database including, but not limited to, texts, images, videos, audio, transactional data, etc.

In some approaches, the AI model may use natural language processing (NLP) to ingest the database associated with use of user data. For example, in some approaches, the AI model uses NLP to ingest data governance measures of the database. According to some approaches, the data governance measures include text of government websites. In some other approaches, the data governance measures may include statutes associated with laws that govern the user data. A technical effect of using NLP to ingest the database includes streamlined processing of text-based information that the trained AI model is then able to use to secure the user data.

As the AI model is trained to do during training of the AI model, in some approaches, the AI model is caused to, e.g., instructed to, based on the ingestion, generate first classifications for the user data (classifications of a relative sensitivity of at least a portion of the user data), e.g., see operation 312. Various examples of user data classifications are described elsewhere herein. For example, the first classification of the user data may include a relatively strict classification of user data for at least a first portion of the user data. In another example, the first classification of the user data may classify another portion of the user data as user data that is subject to being protected to at least some degree, less protected than the relatively high value data described above, yet not a relatively lowest degree of protection. In yet another example, the first classification of the user data may classify another portion of the user data as user data that does not need to be protected, e.g., data that is available for public disclosure and/or inspection.

The AI model, in some preferred approaches, utilizes a dynamic classification engine that leverages NLP and machine learning (of a type that would become apparent to one of ordinary skill in the art after reading the descriptions herein) to continuously analyze the user data (content) of the database. This engine may be used to assess a relative sensitivity of a given portion of user data based on predefined and/or evolving criteria that, in some approaches, consider not only the user data itself, but also the geographical and compliance context in which the user data may be shared. In some approaches, this context includes user roles on multiple endpoints of the connection (such as multi-person calls, meetings, chats, etc.), time of access to user data, location of a user and/or user device that is attempting to access the portion of the user data, etc.

The classifications of different portions of the user data of the database may be subject to ongoing reconsideration by the AI model and thereby may dynamically change at any time. For example, in response to a determination that a portion of the user data is modified, the AI model may analyze the modified data and potentially reclassify the updated portion of the user data. In some approaches, the dynamic classification engine may be used by the AI model to integrate real-time contextual analysis into dynamic adjustment of user data classifications. For example, a first portion of the user data may be a dataset that is historically typically classified as relatively low sensitivity user data which is subject to enforcement of a plurality of security measures. A determination may be made, based on the AI model's analysis of contextual information, that the dataset is being shared under predefined suspicious circumstances. For example, an analysis of the contextual information may reveal that the dataset is being shared with a user device from a foreign IP address and/or during non-typical collaboration hours. In response thereto, the AI model may automatically elevate a sensitivity level of the current classification of the data set, e.g., to a relatively highest classification. In some approaches, other predetermined precautionary response measures may additionally and/or alternatively be performed, e.g., data sharing alerts may be triggered.

Operation 314 includes causing the AI model to determine security measures associated with the first classifications. Determination of security measures for the classifications of user data has a technical effect of ensuring that the user data is secured to an appropriate degree during use of the user data. More specifically, because different portions of user data may be classified differently (have different relative degrees of privacy, be subject to different restrictions and/or rules, etc.) the ongoing determination of the different security measures ensures that each portion of data is secured according to requirements of the classification.

The security measures associated with the first classifications are, in some approaches, determined based on the data governance measures mentioned elsewhere above. For example, in some approaches, a result of the AI model using NLP to ingest data governance measures of the database includes rules that different portions of the user data are subject to.

The determination of the security measures associated with the first classifications, in some approaches, includes considering scheduled events, e.g., collaboration events, in which portion(s) of the user data will be used. More specifically, in some approaches, these scheduled events may be considered because the participants of the collaborative events may hold different credentials. These different credentials may allow some of the participants to have permission to access and/or know details pertaining to some portions of the user data while other users do not have permission to access and/or know details pertaining to the portions of the user data. A use case example of considering scheduled events in order to determine security measures associated with the classifications of user data is described in detail below.

In some approaches, the determination of the security measures associated with the first classifications includes identifying that a first collaboration event is scheduled to occur. In some approaches, the first collaboration event includes an in-person meeting of a plurality of users. In some other approaches, the first collaboration event additionally and/or alternatively includes a virtual meeting that a plurality of user devices are invited to join. In yet another approach, the first collaboration event additionally and/or alternatively is defined by a geographical location with locational boundaries that users may enter and exit from, e.g., a convention booth that a company hosts. Within an environment and/or locational boundaries that such a collaboration event occurs in, potential users and/or user devices that may have access to the user data during the first collaboration event may be determined. This access may be based on one or more sensory types of perception. For example, in some approaches, the access to the user data includes digital access via a user device, e.g., viewing access, download access, upload access, modification authorization, etc. In some other approaches, the access to the user data may additionally and/or alternatively include listening access which may be based on access to an audio stream and/or being within eavesdropping range of the collaboration event. In yet some other approaches, the access to the user data may additionally and/or alternatively include viewing access which may be based on access to a video stream and/or being within viewing range of the collaboration event.

Rules that the identified user devices and/or users are subject to and/or credentials, permissions, passwords, encryption keys, etc., that the user devices and/or users possess may be considered to determine rules to enforce during the collaboration event as a part of the security measures. For example, in a first approach, these determinations may include determining rules that users of the user devices are currently respectively subject to, which may be based on currently assigned roles of the users and/or the users of the user devices. Once these rules are established, in some approaches, method 300 includes ordering the determined rules according to degrees of strictness, e.g., from relatively least strict to relatively most strict. In some preferred approaches, a relatively strictest rule of the ordered determined rules is enforced for the enforcement of the security measures. A technical effect of enforcing a relatively strictest rule of the ordered determined rules includes ensuring that users and/or user devices with relatively lower credentials that participate in collaboration events are not able to access user data that the credentials are not allowed to access. More specifically, the technical effect includes securing all user data by preventing users and/or user devices with relatively lower access credentials from being able to access some user data based on the attendance of users and/or user devices with relatively higher access credentials in the collaboration event.

The rules mentioned above may additionally and/or alternatively be determined based on other relevant information, which may be information identified within the database that the AI model ongoingly ingests. In one approach, one or more of the rules may be based on relevant information that includes primary locations of the users, which may be defined as locations that the users have spent a majority of their time at during previous accesses to the user data, locations that the users have spent time at and have been verified as being secure locations for hosting a collaboration event, locations that the users work at, locations with one or more monitoring device tools that can be used to enforce security measures, etc. One or more of the rules may additionally and/or alternatively be based on relevant information that includes current locations of the users and/or user devices used by the users. One or more of the rules may additionally and/or alternatively be based on relevant information that includes user roles of the users, which may be dynamically assigned, e.g., such as by a company that owns the user data and/or that the user works for. The rules may additionally and/or alternatively be based on relevant information that includes access privileges of the users, which may be of a type that would become apparent to one of ordinary skill in the art after reading the descriptions herein. Accordingly, these rules establish aggregated access permissions based upon the union of the policies and restrictions, respective to each user that may be a participant in a collaboration event such as a meeting, call, or conversation.

As mentioned elsewhere herein, inefficiencies and lack of user data security result from static data classification policies. Accordingly, in addition to the classifications of user data being dynamically performed in the operations described herein, in some approaches, the security measures may be dynamically determined. A technical effect of dynamically determining security measures includes ensuring that changing conditions of collaboration events and/or changes to an environment in which the user data is being used do not result in a loss of security to the user data. In order to prevent static data classification policies, the AI model, in some approaches, monitors use of the user data, such as during collaboration events. This way, changes that create different conditions that the security measures are determined to be based on are recognized and used to dynamically update the security measures. For example, in some approaches, the determining the security measures associated with the first classifications includes determining that participants of the first collaboration event have changed, e.g., user devices are added to the first collaboration event and/or user devices drop off of the first collaboration event. In response to a determination that at least one of the user devices associated with a first of the users has logged off of the first collaboration event, method 300 includes re-determining the security measures associated with the first classifications.

Operation 316 includes causing, e.g., instructing, the AI model to enforce security measures associated with the first classifications during a first collaboration event of a plurality of user devices. Enforcement, in some approaches, is defined as an affirmative action taken to cause the determined security measures to be followed. In some approaches, this affirmative action may include performing filtering, e.g., filtering out portions of an audio sample, filtering-out portions of a video sample, redacting at least some portions of the user data from a document that is displayed and/or output and/or downloaded, etc.

It should be noted that, in some preferred approaches, the AI model determines and incorporates contextual information into the enforcement of the security measures. The contextual information provides the AI model with insight as to how conditions of the meeting may change, where such changing conditions may result in different security measures being enforced. Various types of potential contextual information are described elsewhere herein. This contextual information may, in some approaches, additionally and/or alternatively include an agenda for the first collaboration event. In some other approaches, the contextual information may additionally and/or alternatively include a meeting location for the first collaboration event. In yet some other approaches, the contextual information may additionally and/or alternatively include environment settings of users of the user devices, e.g., whether the participants are located in a public setting, whether the participants are located in a private setting, whether private listening devices (headphones) are being used by the users while participating in the meeting, etc.

A technical effect of incorporating contextual information into the enforcement of the security measures includes alignment of the security measures that are enforced at any given time with conditions of an environment that the user data is being used in.

Various examples of enforcement of the security measures are described below.

In a first approach, the enforcement of the security measures comprises generating a list of acceptable discussion topics and unacceptable discussion topics based on roles of users of the user devices and the first classifications. These discussion topics may be of a granularity that depends on the approach. For example, the discussion topics may, in some approaches, detail relatively more specificity for a first portion of the user data classified as relatively high sensitivity, while in contrast, the discussion topics may, in some approaches, detail relatively less specificity for a second portion of the user data classified as relatively low sensitivity. This way, discussion and/or collaboration actions using user data associated with relatively high sensitivity is clear to users and/or user devices. Entries of the list may be caused to be distributed and displayed on augmented reality (AR) interfaces of the user devices, in some approaches. For example, display of the lists on the user devices may include emphasizing warnings in response to a determination that a discussion during the first collaboration event includes topics having at least a predetermined degree of similarity with the unacceptable discussion topics. Furthermore, in some approaches, in response to a determination that the discussion during the first collaboration event does not includes topics having at least the predetermined degree of similarity with the unacceptable discussion topics and/or includes topics having at least the predetermined degree of similarity with the acceptable discussion topics, the AI model may be caused to output an icon for display on the displays, e.g., a green check mark that is pre-associated with indicating acceptable discussion topics.

In some approaches, in order to determine the topics, the AI model leverages user “profiles” including roles and privileges as well as compliance documentation for organizations that own and/or control transactions which may be associated with a hierarchical structure of accounts. The AI, in some approaches, additionally and/or alternatively may leverage geography based regulatory compliance techniques of a type that would become apparent to one of ordinary skill in the art after reading the descriptions herein, to detect the appropriate topics for discussion to an audience in a collaboration event based on consideration of every single participant.

A technical effect of generating a list of acceptable discussion topics and unacceptable discussion topics based on roles of users of the user devices and the first classifications includes the enablement of streamlined collaboration events. Without such a list, users remain unaware of which topics are acceptable and which topics are unacceptable. Users being unaware of such topics would otherwise result in unauthorized use cases of at least some portions of user data which thereby compromises a security of the user data.

The AR interfaces mentioned above, in some approaches, are user interfaces. A technical effect of using these interfaces includes a reduction in human error (that would otherwise be introduced by humans attempting to enforce such dynamic security measures) and enhancement to data handling compliance. In one or more approaches, a system infrastructure associated with the techniques described herein may include an AR interface that visually displays data sensitivity levels and security protocols directly in the user's field of view. This immediate, intuitive feedback helps ensure that all personnel interact with data in a manner consistent with determined sensitivity levels of the data (defined by the dynamic classifications). Current compliance and legal requirements may additionally and/or alternatively be displayed. The AR interfaces may, in some approaches, include hardware features that may be used to issue alerts and/or visual cues to the users. These alerts and/or visual cues, in some approaches, include links to the associated policy to which an alert is triggered. Note that, depending on the approach, these alerts may be generated in instances where the in-place security measures are at risk of being breached and/or in response to a determination that a breach has occurred. In some other approaches, the alerts and/or visual cues may additionally and/or alternatively include color coded cues. For example, these color coded cues may be used to contrast documents being viewed, which may be based on the NLP detected dialogue being spoken. SMS, email, and/or chat alerts may optionally also be indicated on the user devices. Furthermore, in some approaches, alerts triggered to designated enterprise administrators may additionally and/or alternatively be cast to a display of the AR interfaces.

In one use case example, the AR interface may be a component of an AR headset that is tethered to a mobile device, while operation on the mobile phone may reveal contextual information such as policy information. In such a use case example, notification and alerts may be displayed to the user through a Human Machine Interface (HMI). In another use case example, no headset is used and instead, feedback may be provided to the user through audio only samples provided to affected participants, e.g., or text, chat or email notification directly to affected participant.

With continued reference to operation 316, the enforcement of the security measures, in some approaches, comprises selectively performing a blocking action. For example, in response to a determination that a discussion during the first collaboration event includes topics having at least a predetermined degree of similarity with the unacceptable discussion topics, a predetermined blocking action is performed (by the AI model) to prevent the unacceptable discussion topics from being shared. In one approach, the predetermined action includes outputting a visual warning to a display of the user device. In another approach, the predetermined blocking action may additionally and/or alternatively include at least temporarily disabling a microphone of one of the users. In yet another approach, the predetermined blocking action may additionally and/or alternatively include at least temporarily disabling audio received by one of the users (having access credentials that do not allow access to the user data being discussed).

A technical effect of selectively performing blocking actions includes the prevention of topics having at least a predetermined degree of similarity with the unacceptable discussion topics being covered during collaboration events. More specifically, the blocking actions serve as affirmative automated steps taken to ensure the security of the user data.

The enforcement of the security measures, in some approaches, additionally and/or alternatively comprises building an audit trail that details the enforcement of the security measures. For context, the audit trail provides a record of the enforcement of the security measures, that can be audited in order to refine an integrity of user data security. In some approaches, the audit trail includes logged instances of unauthorized disclosure of the user data. In other approaches, the audit trail includes a log of topics that were discussed during a collaboration event. In some other approaches, the audit trail includes timestamps that detail the user devices that attended collaboration events. A notification is, in some approaches, output to an administrator device that details instances of the logged instances to enable such audits.

The audit trail is, in some approaches, stored on a blockchain and/or a ledger thereof. More specifically, in one or more of such approaches, log data may be stored on a blockchain based accessible database that can provide transparent access to regulatory authorities. In some other approaches, the log data and/or information associated therewith may additionally and/or alternatively be added to a training set of data, where the training set of data is used to train a second AI model that is deployed to secure other user data, e.g., for a different data storage infrastructure. The log data may additionally and/or alternatively be stored on a privately owned cloud storage infrastructure in a primary approach.

A technical effect of building and storing the audit trail includes refinement of an accuracy of the AI model. For example, the audit trail may be used to perform an audit to refine an accuracy of the AI model over time. For example, during downtime (less than a predetermined threshold workload) the AI model may use the audit trail to identify misclassifications of user data (as defined by a scenario in which missing context resulted in a classification of user data that incurred as least some latency in a data storage system associated with the user data). This way, the AI model may learn from these misclassifications and refine a classification accuracy by seeking and obtaining additional context in a next classification of the user data.

The dynamic nature of the AI model, in some approaches, is based on feedback-based refinement techniques. For example, in one or more of such approaches, feedback about the first classification may be received. In some approaches, the feedback details whether or not the classifications contributed to any malicious breach events of the user data. In some other approaches, the feedback details one or more changes to policies of the user data. In yet some other approaches, the feedback details one or more changes to user credential and/or user device credentials. In response to receiving feedback associated with the enforcement of the security measures, the first classifications of the user data are updated to second classifications of the user data, e.g., see operation 318.

A technical effect of dynamically classifying the user data, including using feedback measures for potentially reclassifying the user data, includes ensuring that classifications and associated security measures are kept up to date with use case and environmental conditions of the user data.

It should be noted that the techniques of method 300 preferably may be used as a scalable and customizable framework. In other words, the techniques described herein may be dynamically adapted to be inherently scalable, capable of adapting to different platforms of communication including in-person meetings, phone calls, virtual meetings, etc. Furthermore, these techniques offer customization options for different industries and organizations, allowing these techniques to tailor criteria of the classifications and security measures based on specific needs of different use cases and changing regulatory requirements of any scale.

Several use case examples in which the techniques of method 300 may be used to secure user data are described below.

A first use case example involves a data use environment in which a corporate IT manager, that works at a multinational corporation, is tasked with ensuring that sensitive user data is protected across global offices while adhering to regional data protection laws. These laws change over time, and thereby upon static policies and classifications that the manager applies becoming outdated, the user data becomes out of compliance and at risk. In order to mitigate the latencies and risks associated with these static policies, the techniques of method 300 may be used to cause an AI model to be trained and deployed to perform data ingestion to determine classifications of the user data and appropriate security measures. These security measures, in some approaches, include permission aggregation, where security policies, compliance guidelines, and user access roles are dynamically combined to create tailored permissions for event specific uses of the user data (collaboration events). Context evaluation is used by the AI model to generate security measures that when enforced, restrict inappropriate topics and file-sharing from occurring in a meeting agenda and location. Real-time NLP processing, alerting and selective blocking actions prevent unauthorized user data sharing attempts and notify the manager instantly. This dynamic, adaptive approach ensures regulatory compliance and reduces the manual burden of managing global data security.

A second use case example involves a company merger. During the merger between two companies in different jurisdictions, the techniques described herein may be used to dynamically assess and classify data from both companies, ensuring compliance with the strictest regulations. A technical effect of context evaluation operations described herein includes the generation of tailored rules for integration processes, while real-time NLP processing monitors conversations to prevent data mishandling. AR integration, in some approaches, enhances security by visually flagging sensitive data with color-coded indicators and providing compliance prompts in the participants'field of view during meetings (both internally and with clients). For example, in some approaches, sensitive personal details may be highlighted in red, while compliance links may be displayed for quick reference. These visuals ensure secure and error-free data integration, enabling a seamless merger process while minimizing compliance risks.

Data compliance techniques described herein help mitigate malicious threats and keep customer data safe. Specifically, these measures establish a set of controls (data compliance standards) that organizations and individuals are prompted to follow when handling data. The purpose of these compliance requirements is to ensure safeguards that protect data privacy and prevent data misuse. Data compliance also helps organizations and individuals develop policies and procedures to more responsibly handle data. These techniques enable potential mitigation against data compliance and security breaches, ensuring that confidential high value data is secured. For instance, for data related to focus areas of high strategic value to leadership teams, the techniques described herein may be used to cause the AI model to learn the contextual subject matter of relatively high value data and protect this data from being shared through intelligent blocking, recommendations and alerts. Accordingly, these techniques may be offered as a service in some use cases.

A technical field in which these data securing techniques may be deployed includes healthcare. In such a deployment, the trained AI model safeguards sensitive patient information, ensuring data security and compliance with regulations. Another technical field includes finance. In such a deployment, the trained AI model dynamically classifies and protects sensitive financial data, ensuring compliance with regulations and preventing fraud through real-time recommendations. Yet another technical field includes retail. In such a deployment, the trained AI model helps protect customer data while optimizing personalized shopping experiences through contextual analysis and prevent data breaches.

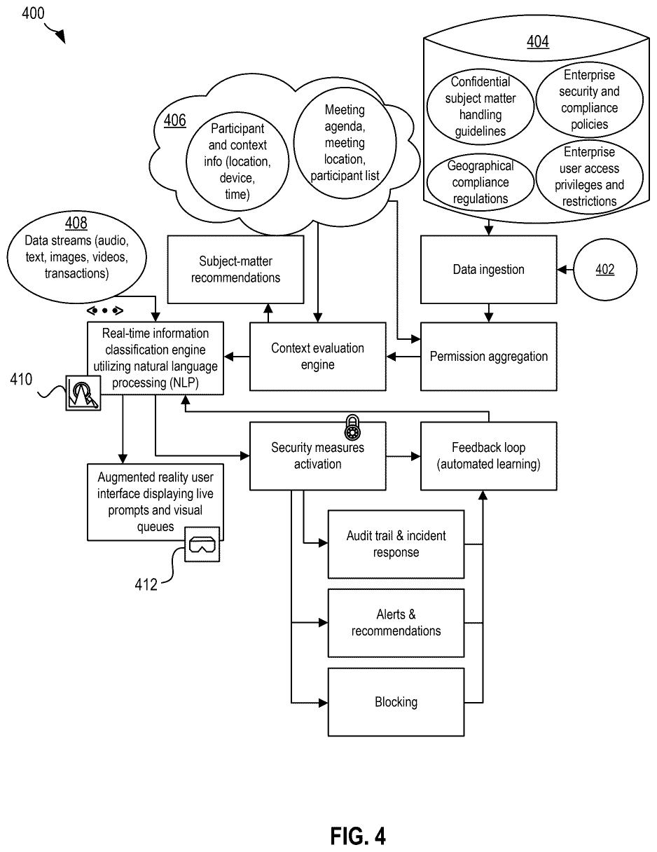

FIG. 4 depicts an infrastructure 400 of an AI model, in accordance with one approach. As an option, the present infrastructure 400 may be implemented in conjunction with features from any other approach listed herein, such as those described with reference to the other FIGS. Of course, however, such infrastructure 400 and others presented herein may be used in various applications and/or in permutations which may or may not be specifically described in the illustrative approaches listed herein. Further, the infrastructure 400 presented herein may be used in any desired environment.

The infrastructure 400 is, in some approaches, associated with a comprehensive system and method designed to revolutionize the way data is shared across globally located companies, and across multiple platforms. The AI model associated with the infrastructure is trained using techniques described herein to address the inherent limitations of traditional static data classification systems by deploying a fully dynamic, adaptive, and scalable approach. Central to these techniques is the ability to continuously analyze and adjust the classification of data (user data) based on its content, context, and associated compliance and regulatory policies. This is facilitated through a sophisticated integration of machine learning, AI, and real-time analytics. These techniques enable real-time feedback to be provided to participants enabling immediate awareness of threats to data security.

An operational workflow that may be performed (using the AI model) within the infrastructure 400 is described below.

The operational workflow, in some approaches, includes causing the AI model to perform data ingestion on a database, e.g., see operation 402 and database 404 fed into a data ingestion engine of the infrastructure. The database is, in some approaches, created with an aggregation of different types of information. For example, in one approach, the information includes security and compliance policies, which may be provided by organizations that own and/or control transactions which may be associated with a hierarchical structure of accounts. In another approach, the information may additionally and/or alternatively include confidential subject matter associated handling guidelines. In yet another approach, the information may additionally and/or alternatively include geographical compliance regulations for all areas where companies conduct business or employees/customers may be located. In yet another approach, the information may additionally and/or alternatively include participant roles and access privileges, e.g., such as at organizations that own and/or control transactions which may be associated with a hierarchical structure of accounts.

Another portion of the operational workflow, in some approaches, includes permission aggregation, e.g., see results of the data ingestion feed into permission aggregation in FIG. 4. During permission aggregation available meeting information 406 (note that meetings are also referred to herein as collaboration events). In some approaches, this information is collected through IoT connected calendar and/or applications. In some approaches with respective opt-in and AR integration, visual recognition can be used to identify participants in an in-person meeting dynamically. Using the collected participant list, an aggregated audience access permissions list is then created based upon the union of the above cross-sectional mentioned policies and any restrictions identified by the AI model as a result of performing the ingestion. Participant relevant information collected, in some preferred approaches, includes a primary location of a participant, a current location (if different) of a participant, user role, access privileges of a participant, etc.

The AI model, in some approaches, uses a context evaluation engine, which is shown in FIG. 4 to optionally be fed by the meeting information 406. Prior to the meeting, a dynamic context is derived that is tailored to a specific audience, environment, or platform where data sharing occurs. Context relevant details collected, in some approaches, include a meeting agenda, a meeting location, environment information (public or private setting), etc. An output of the engine, in some approaches, includes a list of generated rules around appropriate and inappropriate topics for discussion within the contextual meeting session. Added restrictions generated into the list may include restrictions and allowances on file type sharing in addition to subject matter sharing, in some approaches.

The AI model may additionally and/or alternatively use a subject-matter recommendation engine, in some approaches. This engine may be trained to utilize the generated rules in combination with the compliance policies and regulations mentioned elsewhere above. In some approaches, an output of the AI model, as a result of using the subject-matter recommendation engine, includes a generated list of summarized recommendations outlining appropriate and inappropriate subject matter (also referred to herein as acceptable discussion topics and unacceptable discussion topics).

The operational workflow, in some approaches, involves use of a real-time information classification engine 410, which may be fed by information streams 408. More specifically, the AI model may use such an engine to utilize real-time NLP data collection for the processing of the information being shared to the participants of meetings (collaboration events). This data is preferably continuously monitored and scanned to both detect when breaches occur as well as prevent and notify before potential breaches occur during the live conversational sessions. Topic modeling algorithms, e.g., such as Latent Dirichlet Allocation (LDA) are, in some approaches, used to extract topics from textual or audio data and probabilities may be assigned to predict the likelihood of a conversation moving towards an unacceptable discussion topics.

The operational workflow, in some approaches, additionally and/or alternatively includes AR display integration. In some approaches, real-time data sensitivity prompts, recommendations, and displaying associated relevant policies in place for the ongoing topic of a collaboration session are displayed within an AR interface 412. This immediate, intuitive feedback has a technical effect of ensuring that all users and/or user devices interact with data in a manner consistent with sensitivity levels of determined classifications. Current compliance and legal requirements may also be displayed.

In some approaches, alerts and visual cues may be incorporated into the AR display. More specifically, these alerts and visual cues may include, e.g., links to the associated policy for which an alert was triggered, color coded cues (for example on documents being viewed by the speaking participant or based on the NLP detected dialogue to actively alert the user), SMS, email, chat alerts to the user, alerts triggered to designated administrator user devices or a meeting host or moderator, etc.

The operational workflow, in some approaches, additionally and/or alternatively includes enforcing determined security measures, e.g., see Security measures activation. In some approaches, this enforcement includes performing real-time information filtering where, in response to a determination that inappropriate information is shared with one or more parties present at a collaboration event that do not have the proper clearances to view such information, the information delivered to such participants may be filtered or blocked before delivery. Examples of enforcement of security measures, in some approaches, include removing attachments from emails, modifying text documents being shared based on participants added to the document, video blurring, audio blocking, etc.

Information logging and incident reporting is another portion of the operational workflow, in some approaches. This logging, in some approaches, includes logging instances of unauthorized data disclosure. In some approaches, the workflow includes notifying appropriate incident response personnel of the events and circumstances of the compliance breach.

A machine learning feedback loop is, in some approaches, incorporated into the infrastructure 400 for enabling automated learning. For events that have been reported to incident response personnel, an incident response process may tag any false positives as such, and the system will dynamically learn and adjust classifications and security measure parameters for future alerts.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
causing an artificial intelligence (AI) model to ingest a database associated with use of user data;
causing the AI model to, based on the ingestion, generate first classifications for the user data;
causing the AI model to enforce security measures associated with the first classifications during a first collaboration event of a plurality of user devices, wherein the AI model determines and incorporates contextual information into the enforcement of the security measures; and
in response to receiving feedback associated with the enforcement of the security measures, updating the first classifications of the user data to second classifications of the user data.

2. The method of claim 1, wherein the enforcement of the security measures comprises: generating a list of acceptable discussion topics and unacceptable discussion topics based on roles of users of the user devices and the first classifications; and causing entries of the list to be distributed and displayed on augmented reality (AR) interfaces of the user devices.

3. The method of claim 2, wherein the enforcement of the security measures comprises: in response to a determination that a discussion during the first collaboration event includes topics having at least a predetermined degree of similarity with the unacceptable discussion topics, performing a blocking action to prevent the unacceptable discussion topics from being shared.

4. The method of claim 2, wherein the enforcement of the security measures comprises: building an audit trail that details the enforcement of the security measures, wherein the audit trail includes logged instances of unauthorized disclosure of the user data; and outputting a notification to an administrator device that details instances of the logged instances.

5. The method of claim 1, further comprising: causing the AI model to determine the security measures associated with the first classifications, wherein the determining the security measures associated with the first classifications includes: identifying that the first collaboration event is scheduled to occur, determining rules that users of the user devices are currently respectively subject to, and ordering the determined rules according to degrees of strictness, wherein a relatively strictest rule of the ordered determined rules is enforced for the enforcement of the security measures, wherein the determined rules are determined based on relevant information selected from the group consisting of: primary locations of the users, current locations of the users, user roles of the users, and access privileges of the users.

6. The method of claim 5, wherein the determining the security measures associated with the first classifications includes: in response to a determination that at least one of the user devices associated with a first of the users has logged off of the first collaboration event, re-determining the security measures associated with the first classifications.

7. The method of claim 5, wherein the AI model uses natural language processing (NLP) to ingest data governance measures of the database, wherein the security measures associated with the first classifications are determined based on the data governance measures.

8. The method of claim 1, wherein the database associated with use of user data details information selected from the group consisting of: security and compliance policies, confidential subject matter, geographical compliance regulations, and role and access privileges, wherein the contextual information is selected from the group consisting of: an agenda for the first collaboration event, a meeting location for the first collaboration event, and environment settings of users of the user devices.

9. A computer program product comprising:
one or more computer-readable storage media; and
program instructions stored on the one or more storage media to perform operations comprising:
causing an artificial intelligence (AI) model to ingest a database associated with use of user data;
causing the AI model to, based on the ingestion, generate first classifications for the user data;
causing the AI model to enforce security measures associated with the first classifications during a first collaboration event of a plurality of user devices, wherein the AI model determines and incorporates contextual information into the enforcement of the security measures; and
in response to receiving feedback associated with the enforcement of the security measures, updating the first classifications of the user data to second classifications of the user data.

10. The computer program product of claim 9, wherein the enforcement of the security measures comprises: generating a list of acceptable discussion topics and unacceptable discussion topics based on roles of users of the user devices and the first classifications; and causing entries of the list to be distributed and displayed on augmented reality (AR) interfaces of the user devices.

11. The computer program product of claim 10, wherein the enforcement of the security measures comprises: in response to a determination that a discussion during the first collaboration event includes topics having at least a predetermined degree of similarity with the unacceptable discussion topics, performing a blocking action to prevent the unacceptable discussion topics from being shared.

12. The computer program product of claim 10, wherein the enforcement of the security measures comprises: building an audit trail that details the enforcement of the security measures, wherein the audit trail includes logged instances of unauthorized disclosure of the user data; and outputting a notification to an administrator device that details instances of the logged instances.

13. The computer program product of claim 9, wherein the operations further comprise: causing the AI model to determine the security measures associated with the first classifications, wherein the determining the security measures associated with the first classifications includes: identifying that the first collaboration event is scheduled to occur, determining rules that users of the user devices are currently respectively subject to, and ordering the determined rules according to degrees of strictness, wherein a relatively strictest rule of the ordered determined rules is enforced for the enforcement of the security measures, wherein the determined rules are determined based on relevant information selected from the group consisting of: primary locations of the users, current locations of the users, user roles of the users, and access privileges of the users.

14. The computer program product of claim 13, wherein the determining the security measures associated with the first classifications includes: in response to a determination that at least one of the user devices associated with a first of the users has logged off of the first collaboration event, re-determining the security measures associated with the first classifications.

15. The computer program product of claim 13, wherein the AI model uses natural language processing (NLP) to ingest data governance measures of the database, wherein the security measures associated with the first classifications are determined based on the data governance measures.

16. The computer program product of claim 9, wherein the database associated with use of user data details information selected from the group consisting of: security and compliance policies, confidential subject matter, geographical compliance regulations, and role and access privileges, wherein the contextual information is selected from the group consisting of: an agenda for the first collaboration event, a meeting location for the first collaboration event, and environment settings of users of the user devices.

17. A computer system comprising:
a processor set;
one or more computer-readable storage media; and
program instructions stored on the one or more storage media to cause the processor set to perform operations comprising:
causing an artificial intelligence (AI) model to ingest a database associated with use of user data;
causing the AI model to, based on the ingestion, generate first classifications for the user data;
causing the AI model to enforce security measures associated with the first classifications during a first collaboration event of a plurality of user devices, wherein the AI model determines and incorporates contextual information into the enforcement of the security measures; and
in response to receiving feedback associated with the enforcement of the security measures, updating the first classifications of the user data to second classifications of the user data.

18. The computer system of claim 17, wherein the enforcement of the security measures comprises: generating a list of acceptable discussion topics and unacceptable discussion topics based on roles of users of the user devices and the first classifications; and causing entries of the list to be distributed and displayed on augmented reality (AR) interfaces of the user devices.

19. The computer system of claim 18, wherein the enforcement of the security measures comprises: in response to a determination that a discussion during the first collaboration event includes topics having at least a predetermined degree of similarity with the unacceptable discussion topics, performing a blocking action to prevent the unacceptable discussion topics from being shared.

20. The computer system of claim 18, wherein the enforcement of the security measures comprises: building an audit trail that details the enforcement of the security measures, wherein the audit trail includes logged instances of unauthorized disclosure of the user data; and outputting a notification to an administrator device that details instances of the logged instances.

21. The computer system of claim 17, wherein the operations further comprise: causing the AI model to determine the security measures associated with the first classifications, wherein the determining the security measures associated with the first classifications includes: identifying that the first collaboration event is scheduled to occur, determining rules that users of the user devices are currently respectively subject to, and ordering the determined rules according to degrees of strictness, wherein a relatively strictest rule of the ordered determined rules is enforced for the enforcement of the security measures, wherein the determined rules are determined based on relevant information selected from the group consisting of: primary locations of the users, current locations of the users, user roles of the users, and access privileges of the users.

22. The computer system of claim 21, wherein the determining the security measures associated with the first classifications includes: in response to a determination that at least one of the user devices associated with a first of the users has logged off of the first collaboration event, re-determining the security measures associated with the first classifications.

23. The computer system of claim 17, wherein the database associated with use of user data details information selected from the group consisting of: security and compliance policies, confidential subject matter, geographical compliance regulations, and role and access privileges, wherein the contextual information is selected from the group consisting of: an agenda for the first collaboration event, a meeting location for the first collaboration event, and environment settings of users of the user devices.

24. A method comprising:
generating a training set of data, wherein the training set of data includes training user data;
using the training set of data to train an artificial intelligence (AI) model, wherein the training includes a first training task that includes training the AI model to generate first classifications for the training user data, wherein the training includes a second training task that includes training the AI model to determine first security measures associated with the first classifications during collaboration events of user devices; and
in response to a determination that the AI model has, as a result of the training, reached at least a predetermined degree of accuracy, deploying the trained AI model to determine and enforce second security measures associated with second classifications during the collaboration events of the user devices in which confidential user data is shared between the user devices.

25. A computer program product comprising:
one or more computer-readable storage media; and
program instructions stored on the one or more storage media to perform operations comprising:
generating a training set of data, wherein the training set of data includes training user data;
using the training set of data to train an artificial intelligence (AI) model, wherein the training includes a first training task that includes training the AI model to generate first classifications for the training user data, wherein the training includes a second training task that includes training the AI model to determine first security measures associated with the first classifications during collaboration events of user devices; and
in response to a determination that the AI model has, as a result of the training, reached at least a predetermined degree of accuracy, deploying the trained AI model to determine and enforce second security measures associated with second classifications during the collaboration events of the user devices in which confidential user data is shared between the user devices.
